(19) United States
(12) Patent Application Publication
(10) Pub. No.: US 2004/0021684 A1
(43) Pub. Date: Feb. 5, 2004

(54) Method and system for an interactive video system

(76) Inventor: Dominick B. Millner, Gainesville, FL (US)

Correspondence Address: KENYON & KENYON, 1500 K STREET, N.W., SUITE 700, WASHINGTON, DC, 20005, US

(21) Appl. No.: 10/200,150

(22) Filed: Jul. 23, 2002

(51) Int. Cl. G09G 5/00

(52) U.S. Cl. 345/719; 345/720

(57) ABSTRACT

A method and system provide an interactive video stream technique that allows pre-determination of interactive objects, on a frame-by-frame basis, within a video stream. The interactive technique allows designation of interactive objects as carried by key-frames, representing the end of a scene, within the video stream. Pre-determined information about the interactive object is provided to the user in response to user selection of the object. The interactive technique may include a video stream player software application that may receive a digital video stream and allow a user to designate the interactive objects within the video stream, and allow a user to select the interactive objects within the video stream during display and be provided with the pre-determined information about the object in response to the user selection.

### TECHNICAL FIELD

The present invention relates generally to digital video communications networks and services. It particularly relates to a method and system for providing user interactivity with a digital video stream during viewing.

### BACKGROUND OF THE INVENTION

Recent years have seen the large growth of digital video communications networks and services. Instead of being limited to renting an analog videotape (e.g., VHS), most users can now rent or buy a DVD (digital versatile disc) video at any local video store. In addition to the DVD's large storage space (e.g., up to 17 gigabytpes) and quality image presentation, a DVD is particularly useful since the digital data format allows for greater user interactivity with the DVD video. Many DVD videos allow a plurality of customized, user interactive functions including play in reverse, jump to different scenes, camera angle selection, freeze frame, and slow motion effects.

Similarly, for TCP/IP-based (transmission control protocol/internet protocol) communications networks (e.g., the internet), digital video streaming has grown in recent years to allow users to download and/or view (playback) their favorite animation, commercials, music videos, movies, and other forms of video entertainment. Digital video streaming is a sequence of frames (“moving images”) that are sent over the TCP/IP-based communications network in compressed form and displayed successively at the user device (e.g., computer) to create the illusion of motion. When audio is also included, the digital stream is often referred to as a media stream. With digital streaming, the video/audio is sent as a continuous stream allowing the user to view the video instantly as it arrives at the user device without first having to download a large file. Alternatively, the video data may be streamed and saved to a file for later viewing by the user. Video streaming may originate from a pre-recorded video file or may originate from a live broadcast.

With video streaming, a particular sequence of frames may be considered to form a “scene”, which is considered to be a continuous action in space and time (i.e., with no camera breaks). A “cut” is a discontinuity between scenes, and may be sharp if it is located between two frames, and gradual if it takes place over a sequence of frames.

To view the video stream, the user device needs a video stream player which is most commonly a special software application that uncompresses and sends the received video data to the user display, and audio data to the speakers for a media stream. Commonly, the player is either an integral part of the user's browser or downloaded (purchased) as a separate application from the manufacturer of the player software. The more popular video stream players include players made by Quicktime, RealNetwork, Microsoft, and VDO that can reach video streaming speeds of up to 8 Mbps (Megabytes/second). FIG. 1 shows a representative example of video streaming by illustrating different screen shots 100, 105 of the movie, “The Patriot”, that was displayed using QuickTime.

However, similar to analog videotape players, most current video stream players lack user interactivity options except for the most basic of video playback functions (e.g., play, stop, forward, fast forward, reverse, and fast reverse). Some video stream player manufacturers have started to incorporate more customized video interaction functions by allowing a user to select an object within a video for interaction. However, these interaction techniques require complex interpolation to follow one or more interactive objects throughout scene changes for the entire video stream. Consequently, errors may often occur especially when trying to follow one or more interactive objects through sharp scene cuts. Other current interaction techniques involve timing requirements that may allow a user to select the interactive object during a limited time duration (commonly 0-5 seconds) when the object appears on the display screen. However, forcing the user to respond under time pressure is not adequately user-friendly, and again frequent errors may occur as the user misses the intended interactive object as the object leaves the screen too quickly.

Therefore, due to the disadvantages of current interactive video streaming techniques, there is a need to provide an interactive video streaming technique that allows dynamic user interaction and takes efficient advantage of the frame format of video streaming

### SUMMARY OF THE INVENTION

The method and system of the present invention overcome the previously mentioned problems by providing an interactive video streaming technique that allows pre-determination of interactive objects, on a frame-by-frame basis, within the video stream. The interactive technique allows designation of interactive objects as carried by key-frames, representing the end of a scene, within the video stream. Pre-determined information about the interactive object is provided to the user in response to user selection of the object. Embodiments of the present invention include a video stream player software application that may receive a digital video stream and allow a user to designate the interactive objects within the video stream, and allow a user to select the interactive objects within the video stream during display and be provided with the pre-determined information about the object in response to the user selection. Further features of the present invention include the addition of a word index providing a listing of the interactive objects in the video stream that allows the user to select the interactive object from the word index to receive the pre-determined information about the selected interactive object.

### BRIEF DESCRIPTION OF THE DRAWINGS

FIG. 1 is an illustrative example of a video stream as displayed by a video stream player in the prior art;

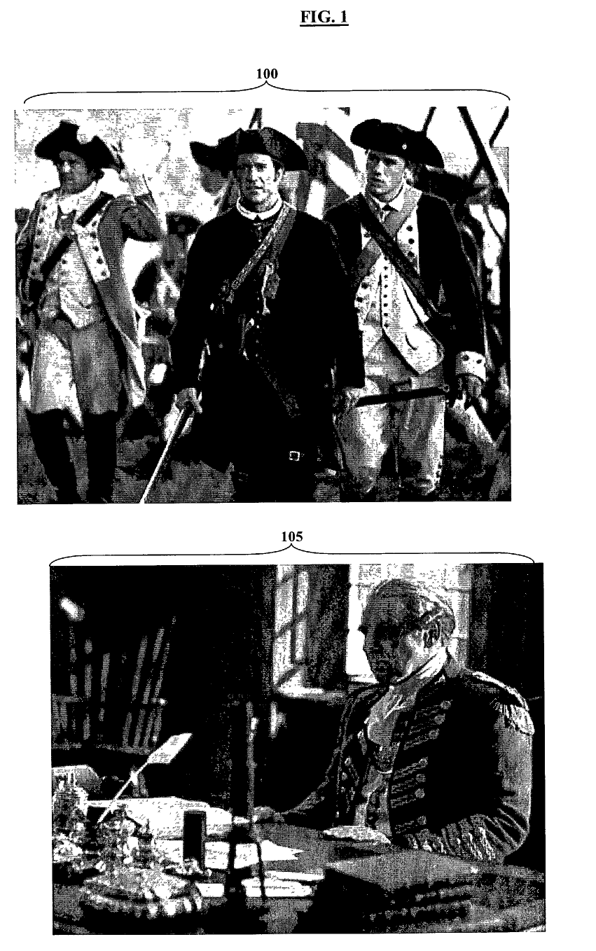

FIG. 2 is a block diagram of the exemplary frame format of a video stream in accordance with an embodiment of the present invention;

FIG. 3 is an illustrative example of a video stream with an interactive object to be designated in accordance with an embodiment of the present invention;

FIG. 4 illustrates a representative flow process diagram in accordance with an embodiment of the present invention.

FIG. 5 is an illustrative example of a first interactive object file in accordance with an embodiment of the present invention.

FIG. 6 is an illustrative example of a second interactive object file in accordance with an embodiment of the present invention.

FIG. 7 is a block diagram of an exemplary video streaming communications system in accordance with an embodiment of the present invention.

FIG. 8 illustrates another representative flow process diagram in accordance with an embodiment of the present invention.

FIG. 9 is an illustrative example of an interactive video stream in accordance with an embodiment of the present invention.

FIG. 10 is an illustrative example of an interactive video stream window in accordance with an embodiment of the present invention.

FIG. 11 is an alternative illustrative example of an interactive video stream in accordance with an embodiment of the present invention.

FIG. 12 is an illustrative example of an interactive video stream in accordance with an alternative embodiment of the present invention.

FIG. 13 is an illustrative example of an interactive video stream in accordance with another alternative embodiment of the present invention.

### DETAILED DESCRIPTION

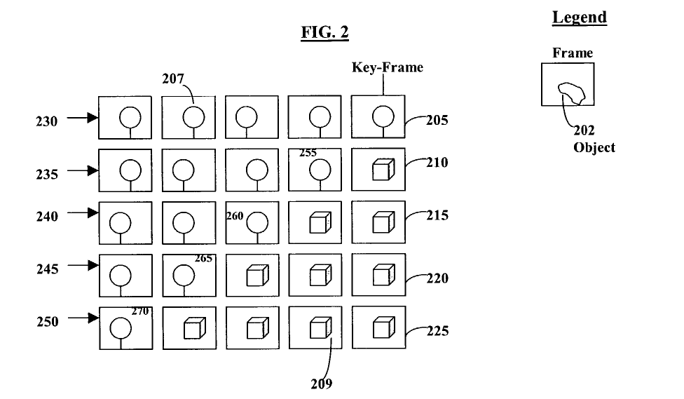

As described herein, the present invention takes advantage of the frame format of digital video streaming to provide an interactive viewing (playback) experience for the user. FIG. 2 is a block diagram of the exemplary frame format of a video stream in accordance with an embodiment of the present invention. In FIG. 2, five exemplary frame sequences 230, 235, 240, 245, 250 of a video stream are shown wherein each frame sequence is composed of five frames. The last frame 205, 210, 215, 220,225 in each sequence is designated as a key-frame. In an exemplary embodiment wherein the transmission (processing) speed for the video stream is 15 frames/second, each five-frame sequence represents 1/3 of a second of user viewing (playback).

As shown in the legend for FIG. 2, there is an object 202 appearing in every frame of the sequences where the object is either a balloon 207 or box 209. Except for the first frame sequence 230, the object shown in the scene portion depicted in the frame (a frame scene portion) may change from a frame scene portion including a balloon 207 to a frame scene portion including a box 209 by the fifth frame in the sequences 235, 240, 245, 250. Advantageously, the sequence of five frames may be considered to form a scene (continuous action in time and space) wherein the object in the frame during the sequence may change as a result of a cut (scene change). Key-frames 205, 210, 215, 220, 225, the last (fifth) frame in each frame sequence, represent the end of a scene.

In accordance with an exemplary embodiment of the present invention, it is useful to designate the object in the key-frame as an interactive object since it represents the end of a scene and therefore should accurately represent any of the previous frames in the sequence. During interactive viewing operation, a user may select the object carried within the five frames of frame sequence 230 and be provided with pre-determined information about the object within key-frame 205 which represents the object selected by the user. Since the object 202 in frame sequence 230, a balloon 207, does not change for the entire sequence, providing information regarding the object 202 (balloon 207) in key-frame 205 is 100% accurate for that particular frame sequence 230. However, if the same approach is used for the other frame sequences 235, 240, 245, 250, errors would result since the object 202 has changed from a balloon 207 to a box 209 by key-frames 210, 215,220, 225. For example, if the user selects the balloon 207 within the second frame of sequence 235 during interactive viewing, and is provided with pre-determined information about the box 209 in key-frame 210, then an error has occurred since the object in sequence 235 has changed from the balloon 207 to the box 209 for the last frame of the sequence (key-frame 210) and therefore is not the actual object selected by the user. Using the single key-frame approach, there is an 80% chance of error for sequence 235 during interactive viewing since user selection of an object in any of the four frames preceding the key-frame 210 will be the balloon 207 and not the box 209 in the fifth frame (key-frame 210). Other error percentages (e.g., 60%, 40%, 20%) during interactive viewing will result for the other sequences 240, 245, 250 since the key-frame object does not represent the same object for the entire 5-frame sequence.

To help eliminate this interactive viewing error, another key-frame (a supplemental key-frame) may be designated in the sequence when the scene change (cut) occurs. As shown in FIG. 2, supplemental key-frames 255, 260, 265, 270 are designated since these frames accurately represent the end of a scene within a sequence when the object 202 changes from the balloon 207 to the box 209. Therefore, during interactive viewing operation, if the user selects the balloon 207 in the second frame of sequence 240, the user is accurately provided pre-determined information about the balloon selected since the balloon is carried by the supplemental key-frame 260 and the information is provided about the object carried within supplemental key-frame 260. And, if the user selects the box 209 in the fourth frame of sequence 240, the user is accurately provided pre-determined information about the box 209 using the box object carried in key-frame 215 as the information reference again. It is noted that the use of a five-frame sequence is solely exemplary and sequences of different lengths may be used in accordance with embodiments of the present invention. Additionally, it is noted that frames within a video stream may carry more than one object and thus more than one object may be designated in a frame for interactive viewing in accordance with embodiments of the present invention.

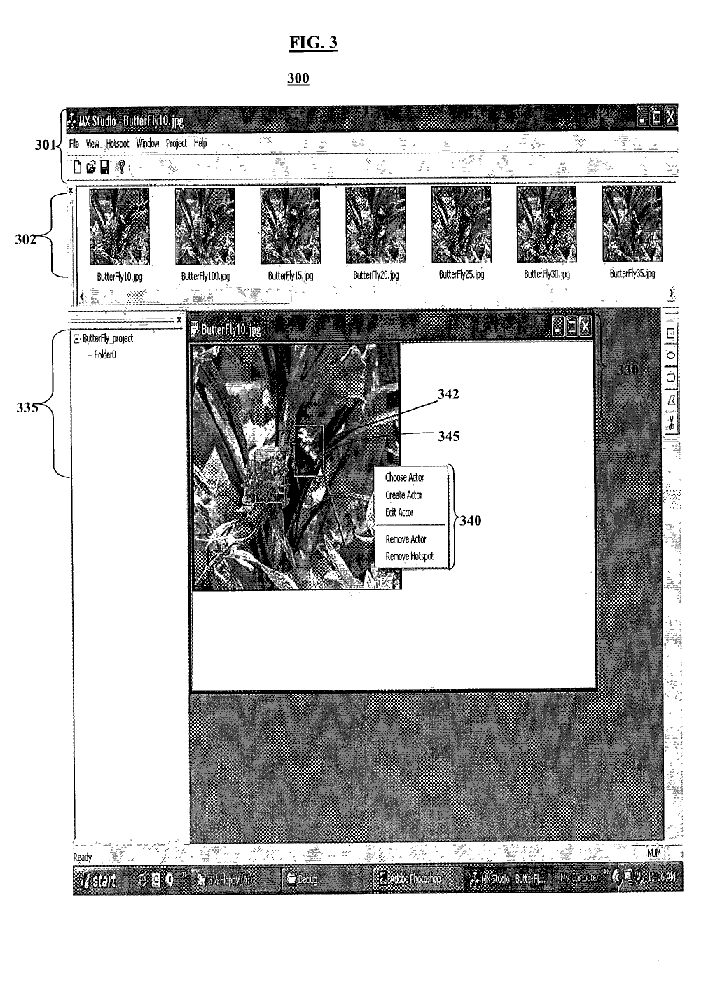

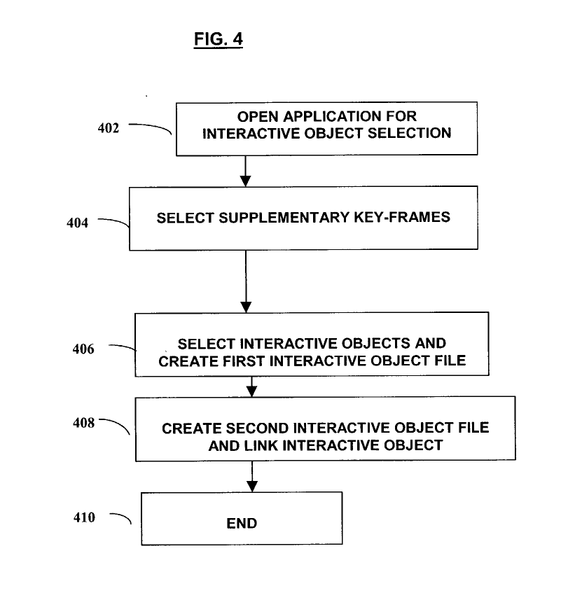

The use of the key-frame approach in creating an interactive video stream is shown in FIGS. 3-4. FIG. 3 illustrates an exemplary video stream with interactive objects to be designated in accordance an embodiment of the present invention. Advantageously, in accordance with embodiments of the present invention, generation (creation) of an interactive video stream may be performed using a video studio software application. The video studio application may be programmed using a suitable programming language such as the C (e.g., C++) programming language. Also, the video studio application may be compatible with various web browsers (e.g., Netscape, Internet Explorer as a client-server software application) and support a TCP/IP communications protocol to receive and display a digital video stream carrying a plurality of frames.

FIG. 4 illustrates a representative flow process diagram showing interactive object designation in accordance with an embodiment of the present invention. At step 402, a user (e.g., developer), optionally from a computer terminal, may open (run) the video studio application to begin the process of selecting (marking-up) interactive objects in a video stream. The video studio application may be integrated with the user's browser (e.g., Netscape, Internet Explorer) or be a separate software application that is opened by the user to begin the designation process. As a separate software application, the video studio application may be downloaded from a remote server or loaded locally from a machine-readable medium including a hard-drive, CD-ROM, floppy disk, or other suitable machine-readable medium. Advantageously, the user may navigate through the interactive object designation process using a mouse-click operation to move forward or backward through the process by clicking on various menu options.

After starting the video studio application, the user may be prompted to input a video stream name (project name) for the current video stream mark-up process. After inputting a video name, “BufterFly” for this exemplary video stream, the user may then receive all the frames from a video stream where the frames may be extracted from the video stream as a TCP/IP compatible image file including GIF, JPEG, or other compatible image files. The video stream may be integrated with the studio application, downloaded from a remote server, or loaded locally from a machine-readable medium including a hard-drive, CD-ROM, floppy disk, or other suitable machine-readable medium.

As shown in FIG. 3, the studio application may include a main window 300 that contains three secondary windows 302, 330, 335 for displaying the video stream to be marked-up on the user computer terminal. The main window 300 may include common menu options 301 for a studio application such as file, view, window, project, and help to allow user navigation of the application. Also, as described herein, the menu options 301 may include a “hotspot” menu option to help further define a user-selected interactive object within the video stream.

In window 302 (e.g., a thumbnail window), the studio application may display the entire frame sequence for the video stream where each frame is advantageously indexed by the user-specified video name and a frame number (e.g., Butterfly10.jpg). In window 330, the studio application may display a currently selected frame to allow the user to designated interactive objects within the selected frame. In window 335, the studio application may display a hierarchical file window which contains the user-specified name (e.g., “ButterFly”) of the video stream on a first level followed by subsequent levels each containing a different key-frame folder for each key-frame in the video stream.

At step 404, the user may be prompted to select supplemental key-frames in the video stream. Using the frame format of FIG. 2, the studio application may automatically pre-designate every fifth frame within the entire frame sequence as a default key-frame. However, due to scene changes (cuts) of the objects in a five-frame sequence, it may be necessary for the user to select supplement key-frames to represent the end of a scene within the five-frame sequence and increase the accuracy of user interaction with a designated interactive object. This step may be continued to select all the supplemental key-frames within the entire video stream. Alternatively, this step may skipped if the user determines that the pre-designated default key-frames accurately represent the end of a scene within a five-frame sequence. As shown in FIG. 3, the user may use window 302 to view a particular frame as part of the five-frame sequence and then use window 330 to designate the selected particular frame as a supplemental key-frame. Alternatively, the studio application may allow designation of the supplemental key-frame in window 302 as well.

At step 406, the user may use windows 330 and 340 to designated interactive objects within a user-selected frame and then create a file associated with the user-selected interactive object. As shown in FIG. 3, window 340 may contain menu options for choosing (selecting), creating, editing, and removing a distinct, interactive object (e.g., “actor”). Window 340 may also contain a menu option for removing a “hotspot” used to help further define the interactive object. Upon selection of “create actor” or a similar option, the user produces a first interactive object file (e.g., “actor file”) associated with the interactive object.

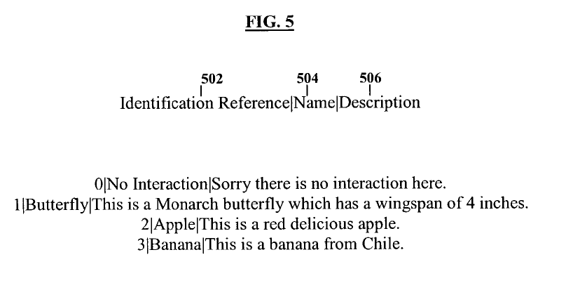

FIG. 5 is an illustrative example of a first interactive object file in accordance with an embodiment of the present invention. In a particular exemplary embodiment, this first file may be referred to as an “actor file”. For this particular example, the user may select the butterfly 342 in the frame ButterFly10.jpg, as shown in window 330, as an interactive object. Upon user selection of the butterfly 342, an actor file opens and the studio application may supply a unique identification (ID) reference 502 for the interactive object, and the user may provide the name 504 of the interactive object (actor), and a description 506 of the interactive object. The unique identification reference and the description may be referred to as an “actor ID” and “actor description” for this example. For this example of the butterfly, the actor ID is 1, the actor name is “Butterfly”, and the actor description is “This is a Monarch butterfly which has a wingspan of 4 inches.” The actor name and description may be edited and/or removed using the edit actor and remove actor menu options from window 340. As shown in FIG. 5, other interactive object examples are given including an apple, a banana, and a default result if no interactive object is within the frame selected by the user. Also, as described herein, the description of the object may include links to further information regarding particular terms within the description. For example, the term “Monarch butterfly” may be hyperlinked (opening up a communications link upon user selection) to a website that provides further information on Monarch butterflies.

At step 408, the user may link (associate) the selected interactive object (“actor”) with a second interactive object file. The second interactive object file may be referred to as a “hotspot file” for this example. The hotspot file helps further define the distinct interactive object within a frame to accurately provide the information from the actor file upon user selection of the interactive object during display of the video stream.

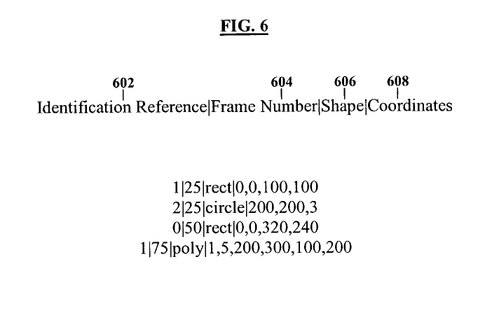

FIG. 6 is an illustrative example of the hotspot file in accordance with an embodiment of the present invention. To create the hotspot file, the user may select a shape for the hotspot, for example using the hotspot menu from menu options 301, drag the shape to a specified size, and then place it over the interactive object in window 330. For this example, rectangle 345 has been chosen by the user as the shape of the hotspot and dragged to cover the butterfly 342 as the specified interactive object. Then, the user links the specified hotspot to an actor by selecting the choose actor menu option from window 340 or alternatively by selecting this menu option from the hotspot menu within menu options 301.

As shown in FIG. 6, each hotspot file includes the corresponding identification reference 602 and frame number 604 for the interactive object (“actor”) to which the hotspot points, the shape 606 of the hotspot, and the coordinates 608 for the hotspot. For this example of the butterfly, the identification reference is 1, the frame number is 25, the hotspot shape is a rectangle, and the coordinates (area enclosed by the rectangle) are 0,0,100,100. Therefore, when the user selects the butterfly 342 within the area enclosed by these coordinates (e.g., moves the mouse cursor over these coordinates or mouse-clicks on the object), the user may be dynamically provided the pre-determined information (name and description from the actor file) regarding actor 1 which may display “Butterfly: This is a Monarch Butterfly with a wing span of 4 inches.” The actor ID and the frame number help link the hotspot to the particular actor. Particularly, the frame number identify what frames correspond to the given area (coordinates). In the hotspot file example of FIG. 6, the butterfly will show up on frame 25 and frame 75 in those respective areas. Also, during this process, the user may associate (e.g., via a hyperlink) each interactive object in the video stream with a particular frame number allowing a user to select the interactive object from a word index listing and be provided the appropriate actor name and actor description for the particular object selected.

Additionally, in accordance with embodiments of the present invention, the shape determines what shape should be drawn by the studio or a video player application as the user selects a particular interactive object. The shape options may include rect (rectangle), circle (circle), poly (polygons), or any other suitable shape to enclose the user-specified interactive object. The rectangle shape may use four numbers for the coordinates (top left x, top left y, bottom right x, bottom right y), the circle shape three numbers (center x, center y, radius), and the polygon shape a plurality of numbers equivalent to the number of sides (coordinate 1 x, coordinate 1 y, coordinate 2 x, coordinate 2 y, etc.), to specify the particular shape dimensions.

After creating the hotspot file, the user may verify and confirm the link of the hotspot to the actor (interactive object). Additionally, the user may remove a hotspot using the remove hotspot menu option from window 340 or alternatively from the hotspot menu within menu options 301. Also, the user may link a hotspot to a different interactive object (actor) by editing the hotspot file, via the menu options 301, to change the actor ID and/or frame number within the hotspot file. Thereafter, the user saves all information regarding the specified actors and hotspots and the process ends at step 410.

Advantageously, the studio application saves the actor and hotspot information to actor.txt and hotspot.txt files, respectively. Thereafter, the user may advantageously export the video stream project including the actor and hotspot files, via the file menu from menu options 301, wherein the studio application may create necessary script and html (hypertext markup language) files, from the actor and hotspot files, to be subsequently used by a video player software application to provide interactive display (playback) of the video stream for the user. Also, it is noted that alternative options may be chosen for allowing the user to create, edit, remove, and save actor/hotbox file information that are in accordance with embodiments of the present invention.

As shown in FIG. 5, if the user does not specify an interactive object (actor) within a frame, the studio application may automatically place a hotspot over the entire frame and provide the “no interaction here” actor information from the actor file. Therefore, advantageously, the user may designate at least one interactive object in each frame of the video stream to avoid this situation and optimize the entertainment value for the user. Additionally, the studio application may allow the user to preview the “marked-up” video stream to verify that all designations of actors and hotspots are accurate to ensure optimum user interactivity during user display of the video stream. Also, the studio application may include an FTP (file transfer protocol) program, via the project menu from menu options 301, to transfer (upload) the newly-created video stream project to a remote server. Thereafter, the video stream project may be downloaded by an end-user, advantageously via a video player software application, to begin interactive viewing of the video stream (e.g., BufterFly).

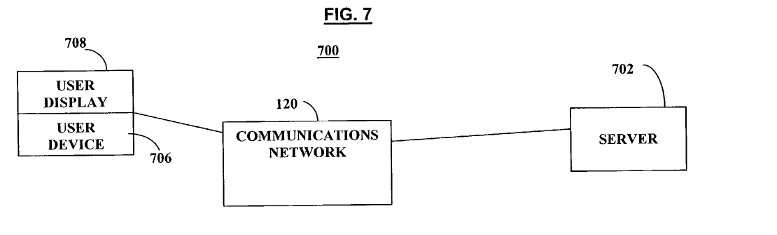

FIG. 7 shows a block diagram of an exemplary digital video streaming communications system 700 in accordance with an embodiment of the present invention. Advantageously, a user may download an interactive video stream from a remote server 702, via communications network 704, using user device 706 and view the video stream upon interconnected user display 708. Although only one communications network 704 and one remote server 702 are shown, it is noted that a plurality of communications networks 704 and servers 702 may be interconnected in accordance with embodiments of the present invention to provide the interactive video stream to the user.

The user device 706 and display 708 may include a variety of user communications devices including computers, personal communications devices/displays, pagers, cellular phones, televisions, digital video recorders, and other suitable user communications devices. Advantageously, the communications network 704 supports a TCP/IP communications protocol to send a video stream, having a plurality of frames, over the communications network preferably at a high data rate (e.g., 15 frames/second). The communications network may include a variety of wired or wireless digital communications networks including the internet, digital satellite network, a packet data network, cellular/PCS network, or other suitable digital communications network. Alternatively, the user may locally load the interactive video stream from a machine-readable medium including a hard-drive, CD-ROM, floppy disk, or other suitable machine-readable medium.

As described herein, the user advantageously may use a video player software application to view the interactive video stream. This video player software application may be downloaded from remote server 702 or another remote server, or loaded locally from a machine-readable medium including a hard-drive, CD-ROM, floppy disk, or other suitable machine-readable medium.

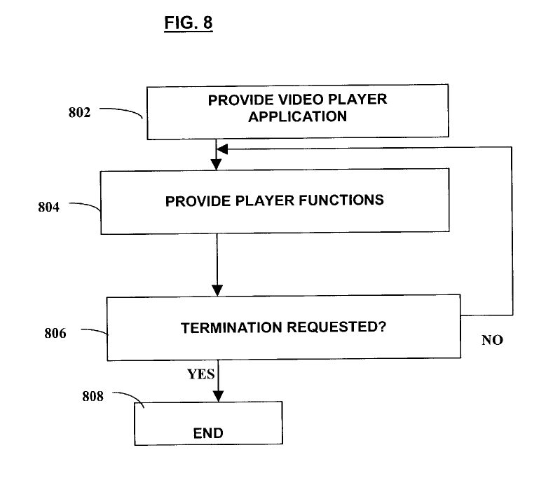

A service provider operation of providing an interactive video stream in response to user selection is shown in FIGS. 8-13. FIG. 8 illustrates a representative flow process diagram showing service provider operation in accordance with an embodiment of the present invention. At step 802, the video player software application is loaded and started for the user. The video player application may be started in response to a user selection, or alternatively may be automatically started as part of a service provider feature. Also, the video player application may be integrated with the user's browser or may be a separate software application that is downloaded or locally loaded as described herein. The video stream to be viewed by the user, and associated video stream project (including hotspot and actor files), may be loaded and started in connection with the video player startup or alternatively may be started at a later time by the user.

Thereafter, at step 804, the service provider, via the video player application, may provide various video player functions to view the video stream including those functions provided in response to user selection of these functions. Advantageously, the user may select particular interactive functions using a mouse-click operation or moving a cursor over the intended selection. A listing of the video player functions that may be performed are included in Table I.

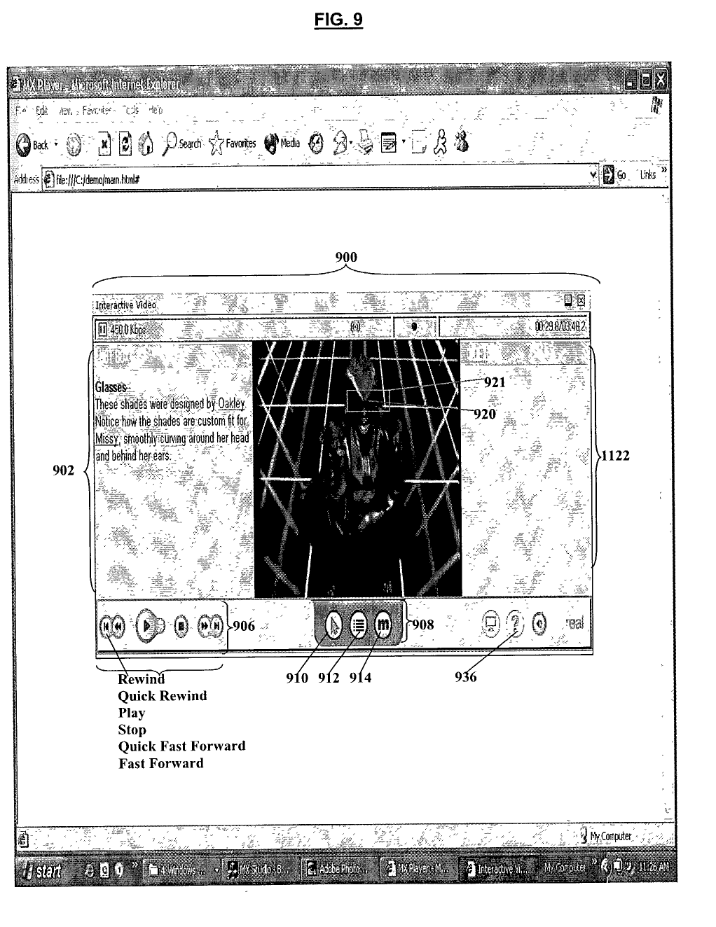

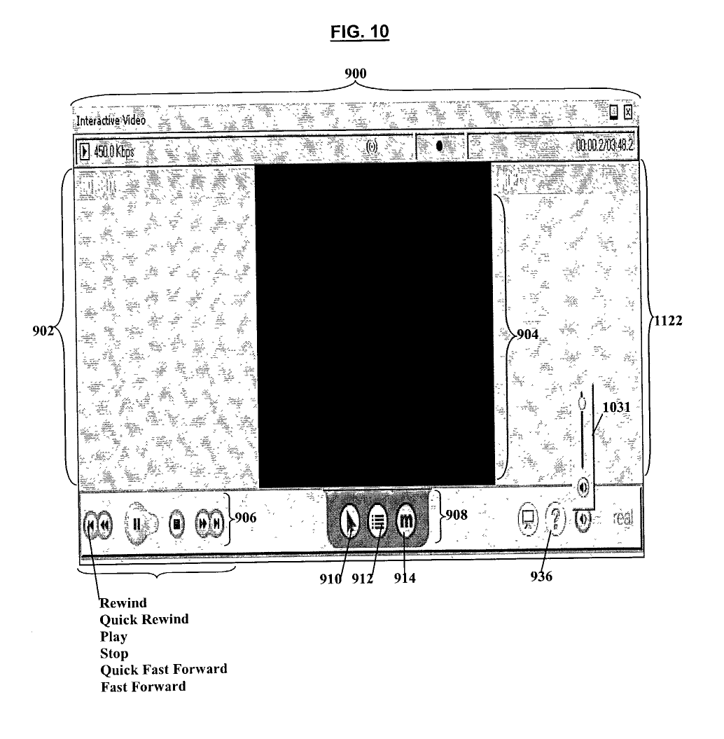

As shown in FIGS. 9-11, the video player may provide a main viewing window 900 on user display 708 that includes a hotbox window 902 and video stream display window 904. The particular display embodiment shown in FIGS. 9-11 may be referred to as a template display mode. The main window 900 may include a plurality of user video playback functions (buttons) 906 (as described in Table I) including (from left to right) rewind, quick rewind, play, stop, quick fast forward, fast forward, and a volume control 1031 (shown in FIG. 10) that help control viewing of the video stream in window 904 in response to user selection. During user playback operation, the user may select the play function from functions 906 and play a video stream (e.g., “Missy Elliott music video”) as shown in window 904. During playback operation, the hotbox window 902 may be closed (not shown) and only the video stream window 904 may be present. Advantageously, windows 900, 902, 904 are projected as a transparent inline image map (e.g., iframe) as read from a html code source.

Also, as shown in FIGS. 9-11, the video player main window 900 may further include a plurality of customized interactive user functions (buttons) 908 including an interact option 910, index option 912, and a menu option 914, as are described in Table I. By selecting (clicking on) the interact option (button) 910, the user may pause the video stream playback (display) in window 904 allowing user interaction (entering an interactive mode) with the one or more interactive objects previously designated within one more frames of the video stream.

As shown in FIG. 9, the user may then select (by passing a mouse cursor over the object) the glasses 920 worn by the person (e.g., Missy Elliott) in the video stream and be provided with the actor name (“Glasses”) and description (“These shades were designed . . . ”) within the hotbox window 902 as the associated actor and hotspot files are read and executed by the video player.

When the glasses are selected within a distinct frame of the video stream, the video player may provide the shape (e.g., rectangle) 921 of the hotbox encompassing the interactive object (e.g., glasses) 920 within the distinct frame as read from the actor and hotspot files. Also, the video player may project the hotspot information (including the actor name and description) within window 902 as processed from an html image code (format) source. Upon entering interactive mode, window 904 may be frozen as a static frame within the video stream. In response to user selection of the glasses, the video player projects an inline image (e.g., gif format), as processed from the html element, in window 902 upon determining the pre-designated key-frame or supplemental key-frame of the frame sequence containing the interactive object selected. This is the key-frame or supplement key-frame representing the end of a scene including the selected interactive object. The hotspot information (including actor name and description) associated with the selected interactive object carried by the particular key-frame or supplemental key-frame is retrieved and swapped with (or presented within) the original transparent image map as the inline image. Advantageously, this inline (I-frame) frame allows hotspot information to be dynamically presented within window 902 for every (different) interactive object carried within distinct frames and chosen by the user during display of the video stream.

Also, in this example, the actor description further provides links (e.g., hyperlinks) to information about particular interactive terms (as highlighted) in the actor description (e.g., “Oakley”, “Missy”). Thereafter, the user, via a browser, may select one or more of the interactive (highlighted) terms to open a communications link to a pre-determined destination (e.g., website) associated with the interactive term to be provided information about the interactive term.

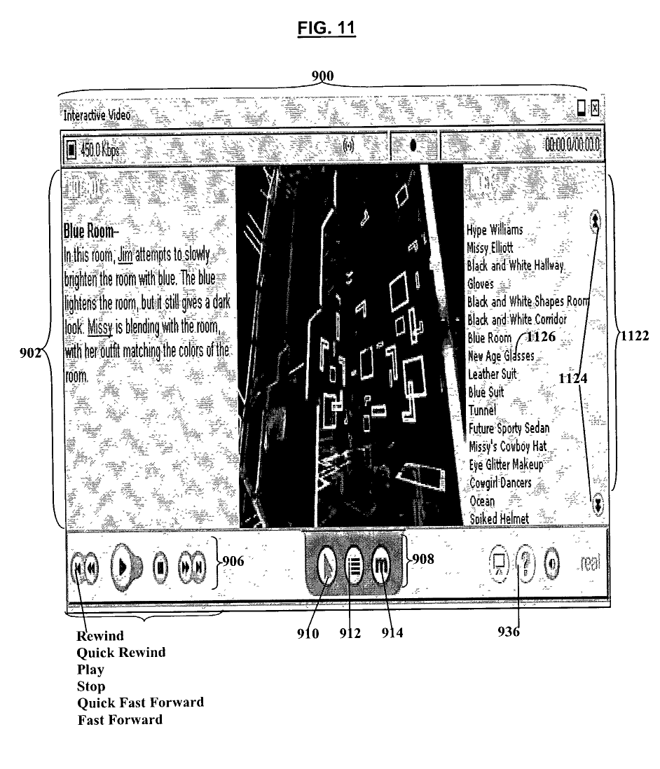

Alternatively, the user may use the index option 912 to initiate the interactive mode with the video stream. Upon user selection of index option 912, the video player provides a window 1122 containing a word index of the interactive objects within the video stream (see FIG. 11). Also, window 1122 may include navigation (scroll) buttons 1124 allowing the user to move up or down the word index. The index window 1122 may further include searching functions allowing the user to search for selected interactive objects in the index and include index functions (as described in Table I) allowing the user to jump to different chronological positions of the video stream wherein the user may either resume the video from the original position or start the video from the new position. To initiate interactive mode using the word index, the user may click on the word (e.g., “New Age Glasses”) 1126 within the word index for the interactive object and the hotspot box and associated information (from the actor file) will be presented in window 902.

After entering interactive mode, the user may continue playback of the video stream by selecting (clicking on) the play option from functions 906. The provision of video player functions at step 804 may continue until the process is terminated at steps 806, 808 by the video player application being terminated (closed) by the user, or alternatively via an automatic shutdown procedure.

Furthermore, the user may select the menu option 914 to receive general information about the video stream (e.g., information about the making of the “Missy Elliott” video”). The menu may come up in an additional menu window 926 as part of a website allowing users to navigate (e.g., search) through the website for more information. Advantageously, the menu may be selected at anytime by the user and may pause the video during playback or take the video out of interactive mode when selected. Additionally, the player main window 900 may include a plurality of other functions including a help option (button) 936 to provide the user with a help guide (e.g., via web pages) to answer questions regarding use of the video player.

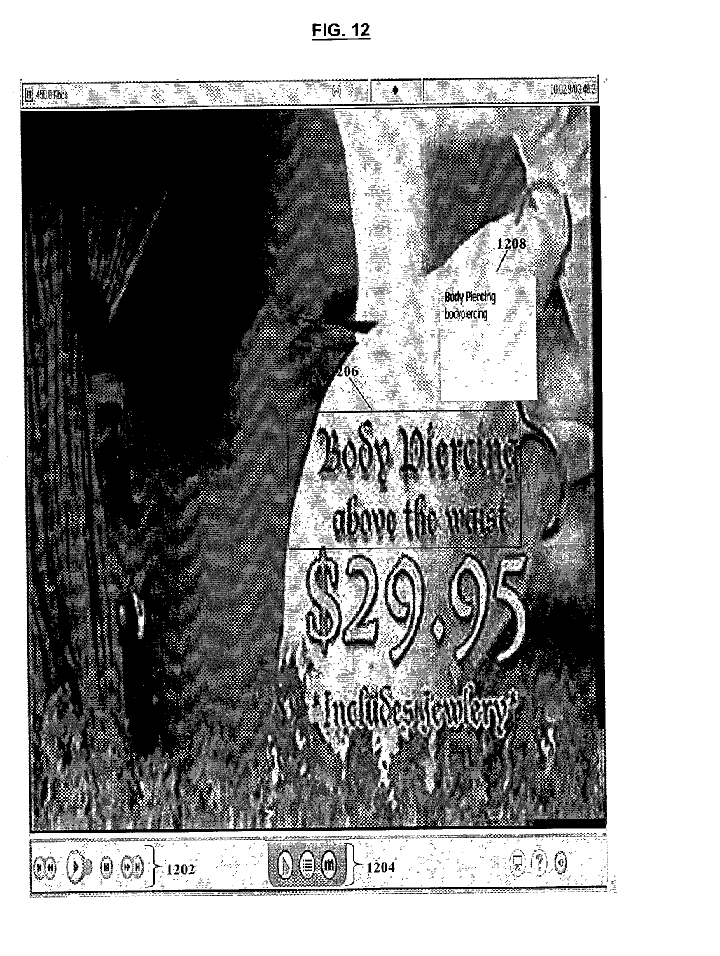

Also, the video player may provide different (scaleable) display modes for the video stream. As shown in FIG. 12, the video player may present the video stream in a full screen display mode, in response to user selection, in accordance with an embodiment of the present invention. Again, full interactive playback and customized viewing options 1202,1204 are provided to the user by the video player. When the interactive object (e.g., body-piercing) within rectangle 1206 is user-selected, the hotbox information (including actor name and description) is provided in (inline) window 1208 that appears within the full screen display. Furthermore, other display modes of varying resolution may be used to display the video stream and/or hotbox information.

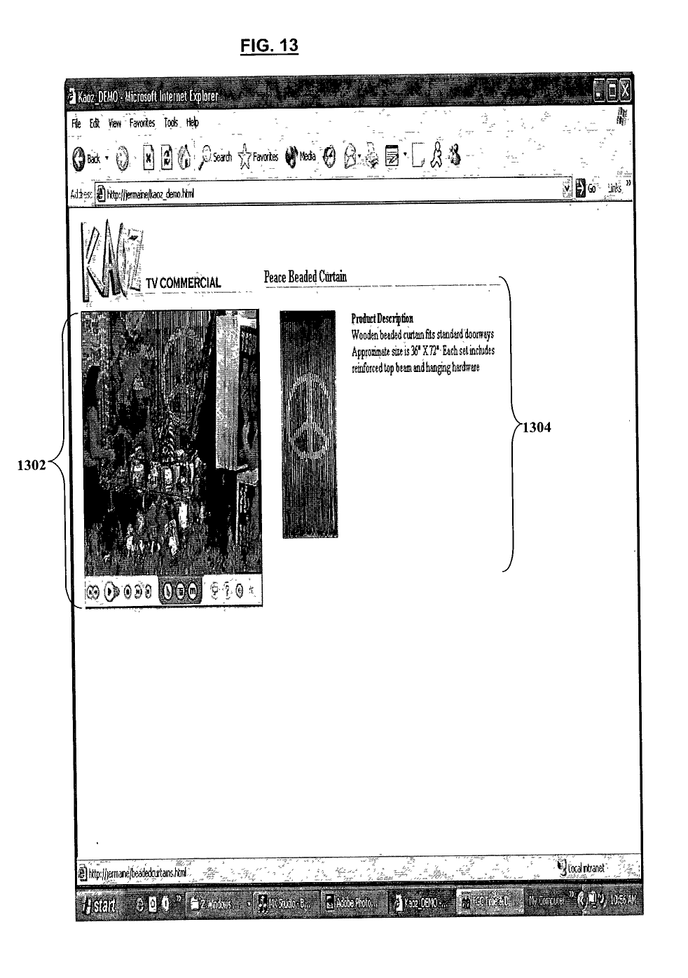

In accordance with embodiments of the present invention, the video player may be implemented as any video player compatible with TCP/IP communications protocol. As shown in FIG. 9, the video player may be implemented in accordance with a video player from RealNetworks and include the interactive features 906 and hotbox information 902 within a main display window 900 common to such video players. Alternatively, as shown in FIG. 13, the video player may be implemented as a customized video player featuring a video stream window 1302 separated from a hotbox window 1304 that displays the hotbox information (including actor name and description) for a selected interactive object.

In an exemplary embodiment, the video player (e.g., Player.html) may be a web-based media player designed by embedding Real Network's Active X image window and status bar. In this particular exemplary embodiment, the video player may also be referred to as “main.html”. The player may be controlled by customized buttons linked to Javascript functions. Advantageously in an exemplary embodiment, the video player may use (process) active server pages (ASP), encoded in html format, to produce the main window 900 including video stream and hotbox windows 902, 904 and the interactive menu functions 906, 908. Alternatively, the player may use any suitable scripting language to produce the main window including the video stream and hotbox windows.

Exemplary html code read by the player to produce the windows and menu functions, and to respond to user interaction functions may include the following:

Status Bar:

<embed width=765 height=27 src=“movie.rpm”

controls=StatusBar console=two></embed>

Active X Image Window:

<embed name=“demo” width=320 height=240 src=“bitch.rpm”

controls=ImageWindow console=two></embed>

User Interaction example:

<a href=“#” onMouseOut=“rollOutMXPlay( )” onDragDrop=“drop( )”

onMouseOver=“rollOverMXPlay( )” onClick=“playVideo( )”><img name=“play1”
border=“0” src=“cimages/button_play.gif” width=“63” height=“52”
alt=“Play/Pause”></a>

The preceding user interaction example may be responsible for calling the appropriate functions when a user clicks a button. For example when the user clicks the play button the playVideo( ) function is called. Also, the rollOutMXPlay( ) function may be responsible for providing the interact buttons and the rollOverMXPlay( ) function may be responsible for swapping in the correct image depending on if the mouse is over the image (e.g., interactive object) or not.

This page may also be responsible for changing the GIF files on mouse being over the image. When the page is loaded it calls the Init( ) function (e.g., a JavaScript file, see Table 1), MM_preloadImages( ). The MM_ApreloadImages function loads all the accompanying images into an array. This is done so that the document does not have to search through a folder for the appropriate image; instead the document searches through an array. Since searching an array is faster than searching a folder (less file I/O's) the images are loaded quicker.

There may be seven layers in the Player.html file. There is one for the volume control which embeds RealNetwork's volume control. There is a layer which covers the video/hotbox area which contains a transparent iframe. The iframe's source is loaded into it upon clicking the interact button (or one of the index links). There is a layer which covers the video area. This layer contains the menu iframe. This iframe is loaded upon loading the player.html file with the menu page. The index layer consists of 3 sub layers. The 3 sub layers include one for the up button, one for the down button, and one for the index information. The index page is loaded into an iframe, which is then loaded into the index information layer. The index layer is shown or hidden when the user clicks on the index button.

Also, one difference between player.html and fullscreen.html (see Table I) is the dimensions of the video window and page. Also, player.html includes hotbox and video stream windows 902, 904. The background gif is not loaded. Also, fullscreen.html sets the status of the video to full screen interactive, whereas player.html sets the status of the video to disable full screen interactive.

In an exemplary embodiment, the video player (e.g., player.html) may use particular html pages (e.g., Movie0.html) to process user selection of interactive objects using the actor and hotspot files wherein illustrative examples are shown in FIGS. 5-6. Movie0.html may be an HTML page that dynamically loads the correct area maps, called hotspots, given a frame number. These area maps may be loaded onto a transparent GIF. The frame number may be passed to movie0.html via the location bar from main.html. Using JavaScript, this page converts the information in the location bar to a string using the function toString( ). After the conversion, it splits the string so that the frame number can be obtained. This frame number is then passed to a function called getFrame(frameNumber). This function is designed to get the closest interactive frame. This is needed because not all the frames in the video are “marked-up”; since they may not be default key frames or supplementary key frames. For example, if frame 22 were passed by main.html, getFrame(22) would search an array for and return (populated by the studio, and sorted in this function) the first frame number that is greater than or equal to the given frame number. The number returned by the getFrame( ) function is then passed to another function called LoadHotspots(frameNumber). The LoadHotspots function is designed to retrieve the correct area tags and coordinates relevant for this frame. The function takes the frame number and search an array (populated by the studio) for the given frame number. Each position in the array has an actor id, a frame number, a shape, and a set of coordinates (in that order) separated by a “|”. An example of a single position in the array may be:

0|5|rect|0,0,320,240

In this case the actor id is “0” the frame number is “5” the shape is “rect” and the coordinates are “0,0,320,240”. After this information is split by the “|” it is pieced together with various html tags to form a complete area map. Using the example above, if the frame number passed to the function was 5, this position in the array would match since 5 is the frame number obtained after the split. The information returned would be:

<area shape= ′rect′ coords=′0,0,320,240′ href=′#′ onMouseOut=
″this.style.cursor=′image′ ″ onFocus=″if(this.blur) this.blur( ) ″ span
id=″temp0″ onMouseOver= “this.style.cursor=′hand′; richToolTip(count)″
onClick=“ modifiers( )” >.

Using the document.write function the information may be written to movie0.html. This is done for every position in the array that matches the frame number passed to the function. The onMouseOut function is used to ensure that the hand returns to the arrow when it is not over the area. The onMouseOver function is responsible for doing two things. First it ensures that when he mouse is over the area the mouse changes to the “hand”. Second, it is used to load relevant information into the hotbox using the richToolTip(count) function. The onClick function calls modifiers( ) to toggle the value of a variable between true and false. The value that is toggled between true and false determines if information in the hotbox changes when the user rolls over another hotspot or the information stays the same. This is needed to prevent the information in the hotbox from changing so the user can interact with that information. In other words, if the user wanted to move his mouse into the hotbox to click on a link, and moved over another hotspot the information that the user wanted to interact with, would not change. The richToolTip(count) function, which is called onMouseOver, makes sure that the hotbox information is not locked. The actual count may refer to the actor ID. If it is not locked, it sets the inner HTML of the layer to that of the hotbox information. This is done by setting an internal layer and calling the loadDesc(actorID) function given the appropriate actor ID. The pop up window's inner HTML is set to the inner HTML of the original layer. The original layer is a placeholder for the hotbox pop up window and its corresponding layer. Then the pop up window is shown. The loadDesc(actorID) function search an array (populated by the studio) for the corresponding actor id. Each position in the array has an actor id, actor name, and the corresponding actor description (in that order) separated by a “|”. An example of a position in the array would be:

0|No Interaction|Sorry No Interaction Here

Each position in the array is split to compare the actor id to the one passed to the function and to get relevant information. In this case the actor id is “0” the actor name is “No Interaction” and the actor description is “Sorry No Interaction Here”. When the function finds a matching actor id it returns the actor description.

Another exemplary web page (e.g., Movie2.html) that assists the video player (e.g., Player.html) may have the same functionality except that it takes the coordinates from movie0.html and uses ratios to calculate the new coordinates for full screen interactive. For x-coordinates, it takes the width of the new video and divides it by the width of the original video (generally 320) and multiplies it by the original x-coordinate. For y-coordinates, it takes the height of the new video and divides it by the height of the original video (generally 240) and multiplies it by the original y-coordinate. The pop up window from richToolTip( ) is loaded near the mouse pointer as they roll over hotspots. The onClick function is not used since a user will not need to hold the hotbox information since it opens right next to the mouse pointer.

Also, instead of the video player being fully integrated with a browser as described herein, the video player may be initially provided separately (stand alone) from the browser and then custom integrated with a browser. The stand-alone player may be a dialog-based application with the Microsoft Web Browser ActiveX control. The web browser loads main.html; all functions are the same as the web version using JavaScript for functionality. To give it the appearance of a stand-alone player the dialog box may be skinned using the Active Skin Control ActiveX object. In short, the stand-alone player may be a dialog box with a web browser embedded in it, which loads the same pages as the web version locally. The information needed to load the correct information may be stored in an .rmi (e.g., RealMedia interactive file). This file would allow opening of media files to be loaded into a movie.html (e.g., movie0.html) file. To open an interactive video the user may load the .rmi file. This file would contain the video location, (like the rpm file) the actor information and the hotspot information. When the user opens an rmi file, the html page (e.g., movie0.html) that has all the information (populated arrays) will be created. The stand-alone player will populate the array based on the .rmi file. When the user closes the player movie0.html (the page that was created) will be deleted. If the user opens a different .rmi file a new movie0.html will be created. The hotbox and index may also be skinned dialog based applications with embedded web browsers which will communicate with main.html the same way the index communicates with main.html in the customized web version.

As described herein, the interactive video experience for the user may be produced using the movie.html files to provide the appropriate hotspot and actor information in response to user selection. Therefore, the actual received video stream does not have to be modified to view it interactively as only a distinct movie.html file, associated with a distinct video stream, has to be created and loaded to view each received video stream interactively. Thus, the interactive video streaming experience for the user is independent of the video stream content.

TABLE I
Customized Functions

| Button | Function | Description of Function |
|---|---|---|
| | Init( ) | This function is called as player.html is loaded. It loads the menu |
| | | (menu.html) into the menu iframe, the index (links.html) in the |
| | | index iframe, and the blank page (with the hotbox image and the |
| | | black background) in the video/hotbox iframe. |
| Play | playVideo( ) | This function makes sure that the video/hotbox and menu layer |
| | | are hidden. It loads a blank page (which contains the hotbox |
| | | image in a black background) into the video/hotbox iframe so that |
| | | we don't see what was in the hotbox previously the next time we |
| | | interact. If the video is not playing and not fast-forwarding or |
| | | rewinding, the video is paused (Real's DoPause( ) function). |
| | | Otherwise, all fast-forwarding and rewinding is stopped, and the |
| | | video is played (Real's DoPlay( ) function). The status of the video |
| | | is set to pause or play, respectively. |
| Stop | stopVideo( ) | This function stops the video (Real's DoStop( ) function) and hides |
| | | the video/hotbox, menu, and index layers. The status of the video |
| | | is set to stop. |
| Interact | interactVideo( ) | If the video is playing, this function pauses the video (Real's |
| | | DoPause( ) function), and calculates the frame number. If we are |
| | | not in index mode, it is the current position (Real's GetPosition( ) |
| | | function) multiplied by the frames per second, divided by 1000 to |
| | | convert from milliseconds to seconds. If we are in index mode, it |
| | | is the frame number that it was given. It then loads the |
| | | appropriate page (movie0.html for regular viewing, movie2.html for |
| | | full screen interactive) into the video/hotbox iframe, and shows the |
| | | video/hotbox layer. The status of the video is set to interactive |
| | | mode. |
| Index | showIndex( ) | If the video is playing, this function toggles the index layer. |
| | setIndex( ) | This function tells the video which interactive frame to jump to and |
| | | sets the video to index mode. It uses the current position in the |
| | | video as the resume position for the resume( ) function using |
| | | Real's GetPosition( ) function. The new position for the video is |
| | | calculated by taking the frame parameter, multiplying it by 1000 |
| | | (to convert it from seconds to milliseconds), then dividing it by the |
| | | number of frames per second. The video is paused (Real's |
| | | DoPause( ) function), the position is set to the new position (using |
| | | Real's SetPosition( ) function), and the video is played (Real's |
| | | DoPlay( ) function). The interactVideo( ) function is then called to |
| | | load the interaction with the given frame. |
| | resume( ) | Resume is used to resume the video from where you left off at |
| | | when using the index. It pauses the video (Real's DoPause( ) |
| | | function), sets the position to the resume position (set when first |
| | | using the index) using Real's SetPosition( ) function), and pauses |
| | | the video (Real's DoPause( ) function). It then calls playVideo( ) to |
| | | start playback of the video again. |
| Menu | showMenu( ) | As long as you are not fast-forwarding or rewinding, this function |
| | | pauses the video (Real's DoPause( ) function), sets the status of |
| | | the video to menu mode, hides the index layer since it cannot be |
| | | used in this mode, and shows the menu layer. |
| Quick | rRewindVideo( ) | If the video is playing, the video is paused (Real's DoPause( ) |
| Rewind | | function), the status is set to quick rewind, and the new position is |
| | | calculated by taking the current position in the video and |
| | | subtracting 3 seconds (this number can vary). If this new position |
| | | is beyond the beginning of the video, the new position is set to |
| | | zero. Using Real's SetPosition( ) function, the video is advanced |
| | | to the new position. The video is played (Real's DoPlay( ) |
| | | function), then paused (Real's DoPause( ) function) to show the |
| | | new position in the video. As long as we are not at the beginning |
| | | of the video, the function is called recursively with a timeout to |
| | | avoid any hang-ups. The timeout is cleared upon entering the |
| | | function again. |
| Rewind | rewindVideo( ) | If the video is playing, the video is paused (Real's DoPause( ) |
| | | function), the status is set to rewind, and the new position is |
| | | calculated by taking the current position in the video and |
| | | subtracting 1 second (this number can vary). If this new position |
| | | is beyond the beginning of the video, the new position is set to |
| | | zero. Using Real's SetPosition( ) function, the video is advanced |
| | | to the new position. The video is played (Real's DoPlay( ) |
| | | function), then paused (Real's DoPause( ) function) to show the |
| | | new position in the video. As long as we are not at the beginning |
| | | of the video, the function is called recursively with a timeout to |
| | | avoid any hang-ups. The timeout is cleared upon entering the function |
| | | again. |
| Quick | fFastForwardVideo( ) | If the video is playing, the video is paused (Real's DoPause( ) |
| Fast | | function), the status is set to quick fast forward, and the new |
| Forward | | position is calculated by taking the current position in the video |
| | | and adding 3 seconds (this number can vary). If this new position |
| | | is beyond the end of the video, the new position is set to end of |
| | | the video (Real's GetLength( )) minus a second to allow room for |
| | | the play/pause. Using Real's SetPosition( ) function, the video is |
| | | advanced to the new position. The video is played (Real's |
| | | DoPlay( ) function), then paused (Real's DoPause( ) function) to |
| | | show the new position in the video. As long as we are not at the |
| | | within one second of the end of the video, the function is called |
| | | recursively with a timeout to avoid any hang-ups. The timeout is |
| | | cleared upon entering the function again. |
| Fast | fastForwardVideo( ) | If the video is playing, the video is paused (Real's DoPause( ) |
| Forward | | function), the status is set to fast forward, and the new position is |
| | | calculated by taking the current position in the video and adding 1 |
| | | second (this number can vary). If this new position is beyond the |
| | | end of the video, the new position is set to end of the video (Real's |
| | | GetLength( )) minus a second to allow room for the play/pause. |
| | | Using Real's SetPosition( ) function, the video is advanced to the |
| | | new position. The video is played (Real's DoPlay( ) function), then |
| | | paused (Real's DoPause( ) function) to show the new position in |
| | | the video. As long as we are not at the within one second of the |
| | | end of the video, the function is called recursively with a timeout to |
| | | avoid any hang-ups. The timeout is cleared upon entering the |
| | | function again. |
| Full | goFullScreen( ) | This function determines whether or not we are in full screen |
| screen | | mode or not. If we are not in full screen mode, then it asks |
| | | whether the user would like to go to full screen or full screen |
| | | interactive, and the appropriate full screen loads. If you are in full |
| | | screen mode (in full screen interactive), it returns back to the |
| | | original video. |
| Help | onHelp( ) | This function toggles between loading the help window and |
| | | closing it. |
| Volume | showVolume( ) | This function toggles the volume control layer. |
| Scroll up | ScrollUp(speed) | This function scrolls the index up using the given speed when you |
| | | mouse over the scroll up button. |
| Scroll | ScrollDown(speed) | This function scrolls the index down using the given speed when |
| down | | you mouse over the scroll down button. |
| | ScrollStop( ) | This function stops the scrolling when you mouse out of the scroll |
| | | buttons. |
| | loadSF( ) | This function is called when the links.html page is loaded. It loads |
| | | the inner HTML of the links page into the index iframe. |

Although the invention is primarily described herein using particular embodiments, it will be appreciated by those skilled in the art that modifications and changes may be made without departing from the spirit and scope of the present invention. As such, the method disclosed herein is not limited to what has been particularly shown and described herein, but rather the scope of the present invention is defined only by the appended claims.

What is claimed is:

1. A method to provide user interaction with a video stream, comprising:
sending a video stream, having a plurality of frames, to a user to be displayed on a user display wherein the video stream includes at least one pre-determined, interactive object carried by at least one distinct frame of the video stream.

2. The method of claim 1, further comprising:
providing pre-determined information to the user about the interactive object in response to user selection of the interactive object during display of the video stream.

3. The method of claim 2, further comprising:
providing a communications link to a pre-determined destination associated with an interactive term included within the pre-determined information in response to user selection of the interactive term.

4. The method of claim 2, further comprising:
providing a video stream player application for the user to receive and display said video stream, and to provide said pre-determined information.

5. The method of claim 4, wherein said video stream player application includes either of a template display mode, full screen display mode, or a customized display mode for said video stream.

6. The method of claim 4, wherein said pre-determined information is provided to the user as processed from a hypertext markup language image format.

7. The method of claim 6, wherein said hypertext markup language image format reduces the storage space of the video stream player application.

8. The method of claim 2, wherein said user selection includes the interactive object being selected from visual display of the object in the video stream.

9. The method of claim 2, wherein said user selection includes the interactive object being selected from a word index listing the at least one interactive object in the video stream.

10. The method of claim 2, wherein said user selection includes the interactive object being selected during an interactive mode of video stream playback wherein said interactive mode allows a user to select the interactive object during display of the video stream.

11. The method of claim 1, wherein said user display includes either of a computer, television, personal video display, cellular phone, or pager.

12. The method of claim 1, wherein said sending includes sending the video stream to the user using a communications protocol including a transmission control protocol/internet protocol.

13. The method of claim 2, further comprising:
providing pre-determined, general information about the video stream in response to a user request.

14. The method of claim 1, wherein said distinct frame is a key-frame, representing an end of a scene, for a pre-determined sequence of frames of the video stream.

15. The method of claim 14, wherein said key-frame is a supplemental key-frame.

16. The method of claim 2, wherein said user selection includes either of a point-and-click operation upon the interactive object or moving a cursor over the interactive object.

17. The method of claim 1, wherein said video stream is either of a animation, movie portion, commercial, or a music video.

18. A method to provide user interaction with a video stream, comprising:
designating at least one interactive object, carried within at least one distinct frame of a video stream, that may be selected by a user during display of the video stream; and
associating said interactive object with information about the object to be provided to the user in response to user selection of said object.

19. The method of claim 18, wherein said associating includes associating said object with a file including an identification reference, name, and said information for said object.

20. The method of claim 18, wherein said designating includes associating said interactive object with a file including an identification reference and a frame number associated with said object, and a shape and coordinates for the frame portion containing said object.

21. The method of claim 18, wherein said distinct frame is a key-frame, representing an end of a scene, for a pre-determined sequence of frames of the video stream.

22. The method of claim 21, wherein said key-frame is a supplemental key-frame.

23. A video stream player application including a plurality of executable instructions, the plurality of instructions comprising instructions to:
receive a video stream, having a plurality of frames, for a user to be displayed on a user display wherein the video stream includes at least one pre-determined, interactive object carried by at least one distinct frame of the video stream; and
provide pre-determined information to the user about the interactive object in response to user selection of the interactive object during display of the video stream.

24. The video stream player application of claim 23, wherein said instructions include instructions to provide a communications link to a pre-determined destination associated with an interactive term included within the pre-determined information in response to user selection of the interactive term.

25. The video stream player application of claim 23, wherein said instructions include instructions to provide either of a full screen display mode or a customized display mode for said video stream.

26. The video stream player application of claim 23, wherein said instructions include instructions to provide said pre-determined information to the user as processed from a hypertext markup language image format.

27. The video stream player application of claim 26, wherein said hypertext markup language image format reduces the storage space of the video stream player application.

28. The video stream player application of claim 23, wherein said user selection includes the interactive object being selected from visual display of the object in the video stream.

29. The video stream player application of claim 23, wherein said user display includes either of a computer, television, personal video display, cellular phone, or pager.

30. The video stream player application of claim 23, wherein said instructions include instructions to receive the video stream for the user using a communications protocol including a transmission control protocol/internet protocol.

31. The video stream player application of claim 23, wherein said video stream is received from a server.

32. The video stream player application of claim 23, wherein said video stream is received from a machine-readable medium.

33. The video stream player application of claim 23, wherein said distinct frame is a key-frame, representing an end of a scene, for a pre-determined sequence of frames of the video stream.

34. The video stream player application of claim 33, wherein said key-frame is a supplemental key-frame.

35. An interactive video system, comprising:
a user device programmable to:
receive a video stream, having a plurality of frames, to be displayed on a user display wherein the video stream includes at least one pre-determined, interactive object carried by at least one distinct frame of the video stream; and
to provide pre-determined information to the user about the interactive object in response to user selection of the interactive object during display of the video stream.

36. The interactive video system of claim 35, further comprising:
a server, having said video stream stored thereon, to send said video stream to said user device.

37. The interactive video system of claim 35, further comprising:
a server, having a video stream player application stored thereon, to send said application to said user to program said user device.

38. The interactive video system of claim 35, wherein said user device is a digital video player.

39. The interactive video system of claim 35, wherein said distinct frame is a key-frame, representing an end of a scene, for a pre-determined sequence of frames of the video stream.

40. The interactive video system of claim 39, wherein said key-frame is a supplemental key-frame.

41. The interactive video system of claim 34, wherein said user device is interconnected to a digital video communications network to receive said video stream as part of a subscription service for a user.

42. A video stream player application including a plurality of executable instructions, the plurality of instructions comprising instructions to:
perform an initialization function as the player application is loaded which includes loading a blank hypertext markup language page into an inline hypertext markup language frame as a placeholder for subsequent video stream frames;
perform a video stream playing function in response to a user selection which includes loading a sequence of video stream frames into said inline frame and swapping out said blank page; and
perform a video interaction function in response to a user selection which includes pausing said sequence of frames on a user-selected frame, determining a frame number for said frame, and loading pre-determined information, including a name and description of a user-selected interactive object carried within said frame, into said inline frame.

43. The video stream player application of claim 42, further comprising instructions to:
perform an index function in response to user selection which includes loading a word index, listing a plurality of interactive objects, into said inline frame.

44. A video stream player application including a plurality of executable instructions, the plurality of instructions comprising instructions to:
receive an unmodified video stream, having a plurality of frames, for a user to be displayed on a user display wherein the video stream includes at least one pre-determined, interactive object carried by at least one distinct frame of the video stream;
provide pre-determined information to the user about the interactive object in response to user selection of the interactive object during display of the video stream.

45. The video stream player application of claim 44, wherein said pre-determined information is provided from a pre-determined file allowing a plurality of distinct video streams, each carrying at least one user-selectable interactive object, to be received and displayed by loading an associated, distinct pre-determined file upon display of one of the plurality of video streams.

46. The video stream player application of claim 45, wherein said associated, distinct pre-determined file is stored in a hypertext markup language format.
